(19) United States
(12) Patent Application Publication
(10) Pub. No.: US 2013/0157664 A1
(43) Pub. Date: Jun. 20, 2013

(54) Broadband Wireless Mobile Communications System With Distributed Antenna System Using Interleaving Intra-Cell Handovers

(71) Applicants: Bruce Cinkai Chow, Brooklyn, NY (US); Ming Li Yee, Singapore (SG)

(72) Inventors: Bruce Cinkai Chow, Brooklyn, NY (US); Ming Li Yee, Singapore (SG)

(21) Appl. No.: 13/818,525

(22) PCT Filed: Aug. 31, 2011
(86) PCT No.: PCT/US2011/049813

§ 371 Date: Feb. 22, 2013

Related U.S. Application Data
(60) Provisional application No. 61/378,932, filed on Aug. 31, 2010.

(51) Int. Cl. H04W 36/20

(52) U.S. Cl. CPC H04W 36/20
USPC 455/436; 455/446

(57) ABSTRACT

A broadband wireless mobile communication system for high a speed mobile transportation corridor comprises a base stations utilizing two or more sectors, a distributed antenna system connected to the base station and including remote antenna units distributed along the corridor and sectors of the respective base station, with sectors of the base station interleaved among the remote antenna units such that no two adjacent antennas use signals from the same sector. The system desirably employs a radio over fiber distributed antenna system which desirably includes an autonomous sensing remote antenna unit structured so as toggle between standby and active modes in response to locally sensed presence of a mobile transceiver along the corridor. A method of operating broadband wireless mobile communication system for high a speed mobile transportation corridor is also disclosed.

This application claims the benefit of priority under 35 USC§119 of U.S. Provisional Application Ser. No. 61/378,932 filed on Aug. 31, 2010 the content of which is relied upon and incorporated herein by reference in its entirety.

### BACKGROUND

Providing wireless broadband access to mobile users traveling at high velocity is a critical step toward the worldwide trend of ubiquitous data access. Users traveling in moving vehicles represent a high demand for data and voice access, particularly in the case of trains. Providing wireless coverage along mobile corridors of travel is often challenging due to difficult terrain, including crowded urban areas, mountainous areas and tunnels, and due to high vehicle speeds.

A number of solutions have been proposed, mostly consisting of deploying additional wireless base stations in the vicinity of the mobile corridor, such as highways and railways. However, increasing the density of base stations increases the number of required handovers between the base stations. In some cases, wireless coverage is plagued by incomplete handovers resulting in reduced throughput and dropped connections.

Another solution is to extend the range of a base station by means of an analog distributed antenna system which replicates the original wireless signal to multiple antenna points along the mobile corridor. More specifically, an analog Radio-over-Fiber Distributed Antenna System (RoF DAS) may be used effectively to extend the range of a base station. The RF output of a base station is replicated into an optical signal which is then transported over fiber to multiple remote antenna units which reconvert the signal back into a copy of the original electrical RF output. In this way, a RoF DAS can be used to eliminate inter-cell handovers in the extended range since all remote units are broadcasting the same signal from the same base station.

While adjacent antenna points transmitting the same signal can eliminate or reduce inter-cell handovers, it can also lead to signal interference between adjacent antenna points, because the signal from each antenna will have a different path length (optical and/or wireless) which may result in time synchronization issues and possible connection failure. In short, a traditional RoF DAS can reduce the number of inter-cell handovers in the system, but will also be susceptible to problems from self-interference between adjacent remote antenna points.

### SUMMARY

Disclosed is a method and system to eliminate the interference between adjacent antenna points while still maintaining the handover advantages of the RoF DAS for high speed mobile transportation corridors. A base station utilizing 2 or more sectors is used as the signal source. A DAS is formed by interleaving the 2 or more sectors such that no 2 adjacent antenna points are using signals from the same sector. In this type of DAS, intra-cell type handovers (sometimes referred to as “softer” or “R6” handovers) are implemented between adjacent antenna points. This differs from a traditional DAS where all antenna points are transmitting the same signal and subject to self-interference. This also differs from a traditional multiple base station scenario where inter-cell handovers are required between antenna points.

Intra-cell handovers are nearly instantaneous and are handled within a single base station. Intra-cell handovers are also much more reliable than inter-cell handovers for highly mobile, or high velocity mobile communications scenarios. Therefore the interleaved intra-cell transfer DAS disclosed herein takes advantage of the DAS architecture while eliminating the self-interference issue, providing economical, low-power and low infrastructure system for providing broadband access to high-velocity mobile users.

A further embodiment of the present invention includes remote antenna units (RAUs) that individually sense the presence of mobile transceivers within the proximity of the respective RAU, switching as needed into active or standby mode. When the RAU senses a mobile transceiver approaching along the route of passage in the vicinity, it will toggle itself to the active mode. In active mode activates the downlink power amplifiers and uplink lasers are powered on, thus completing the communications path to and from a head-end at the base station. The RAU remains active over the duration over which the vehicle remains in its respective service area. When the mobile transceiver leaves the vicinity, the RAU also senses this event and places the downlink power amps and uplink laser back into unpowered standby mode and awaits the approach of the next mobile transceiver to enter the coverage area.

A further embodiment includes a mobile transceiver sensing system to sense the presence of the vehicle carrying a mobile transceiver. This system senses the presence of the mobile transceiver and uses sensor output levels to determine when to place the RAU into active or standby mode. The method of proximity sensing can include, but not limited to, radio frequency signal strength, RFID, Radar, LiDAR, vibrations, acoustics, optical detection, machine vision, Doppler detection, wireless beacon, RSSI, and so forth. Additionally, the sensing implementation may also be a combination of multiple proximity sensing methods.

In traditional RoF RAUs, no provision is made to sense the presence of approaching or leaving mobile transceivers. Vehicle tracking, if any, is performed at the head end or network level. As a result, these traditional RAUs are not be able to toggle between active and standby mode triggered by proximity of a mobile transceiver. Traditional RAUs are always in active mode regardless of whether they are transmitting the signal productively.

In contrast, with local vehicle sensing individually at the respective RAUs, RAUs are not broadcasting unless they are needed, reducing the opportunities for multipath interference. Further, the RAUs according to an embodiment of the present invention RAUs are not transmitting to the head end unless the transmission is needed. This reduces noise and opportunities for interference at the head-end. Power consumption of the system as a whole is also reduced by these features, providing significant advantage with cumulative effect: lower power consumption reduces heat sinking and mass and component spacing requirements, which all reduce total material and weight, which reduces mounting material and strength requirements, all of which reduces footprint and increases the places in which the hardware may be implemented. Low power requirements may also allow multiple RAUs to be supplied from a single power line, lowering the installation cost and speeding the deployment high bandwidth services to high velocity mobile users.

### BRIEF DESCRIPTION OF THE DRAWINGS

FIG. 1 is a diagrammatic representation of inter-cell handover between two base stations in a typical cellular communications environment.

FIG. 2 is a diagrammatic representation of a typical existing base station deployment for wireless coverage along a mobile corridor.

FIG. 3 is a diagrammatic representation an embodiment of a system and method employing a radio-over-fiber distributed antenna system (RoF DAS) with intra-cell handover.

FIG. 4 is a diagram of an embodiment of a remote antenna unit in standby mode.

FIG. 5 is a diagram of an embodiment of a remote antenna unit in active mode.

FIG. 6 is a diagram showing the operation of an embodiment of a radio over fiber distributed antenna system with remote antenna units of the type shown in FIGS. 4 and 5 or similar thereto.

### DETAILED DESCRIPTION

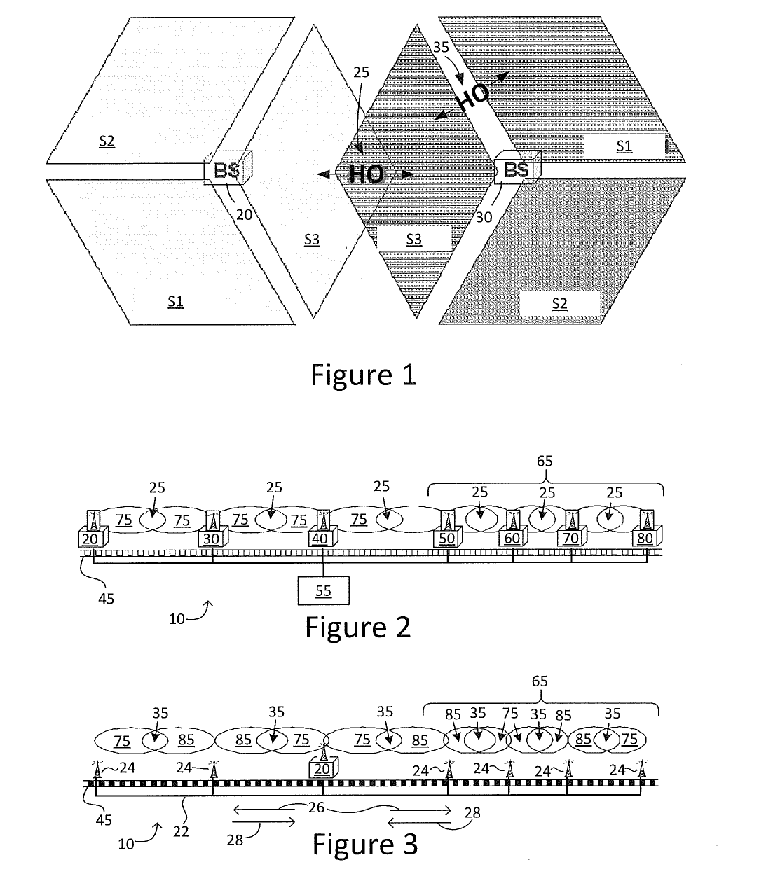

As noted above, FIG. 1 shows a diagrammatic representation of an inter-cell handover between two base stations 20 and 30. Each base station has multiple sectors, in this case sectors S1, S2, S3. A handover from any sector of one base station 20 to any sector of a neighboring base station 30 is an inter-cell type of handover 25. Inter-cell handovers 25 are the most difficult to accomplish because they are managed at the network level. In contrast to inter-cell handovers, intra-cell handovers 35 between sectors (sectors S1 and S3 in the case shown) within a single base station 30 are managed within the base station and are not as difficult, and are accomplished more quickly and reliably inter-cell handovers.

FIG. 2 shows a system 10 having a typical base station deployment to provide wireless coverage to vehicles moving along a high speed corridor, such as along highways and railways, represented by the diagrammatic railway 45. This type of deployment utilizes many base stations 23, 30, 40, 50, 60, 70, 80 each connected to an asynchronous network 55 and therefore requires a large number of inter-cell handovers at locations 25. In a region 65 of difficult terrain such as mountainous terrain, mountainous terrain with tunnels, and the like, the base stations are positioned at a closer spacing along the corridor or railway 45, to preserve adequate overlap of the coverage lobes 75 of adjacent stations. But at high vehicle speeds, such as in the case of bullet trains, the resulting high frequency of inter-cell handovers, particularly in regions 65 of difficult terrain, often results in reduced bandwidth and dropped connections.

FIG. 3 shows a diagrammatic representation of an embodiment of a radio over fiber distributed antenna system, or RoF DAS, employing intra-cell handovers between interleaved sectors of a single cell or base station. The RF signal of a single cell or base station 20 is replicated in the optical domain, transported over an optical fiber link 22, and reproduced at a number of remote antenna units 24. The low loss of the optical fiber link 22 allows the remote antennas 24 to be placed at very long distances away from the base station 20. The RoF DAS extends a base station's range along a mobile corridor 45, thereby reducing the number of inter-cell type handovers by covering much of the corridor 45 with intra-cell handovers 35.

In a typical RoF DAS, only one sector from the base station is used. In such a case, signal interference, or self-interference, between adjacent remote antennas may arise due to the different signal propagation times at different distances. This self-interference may be partly mitigated by equalizing the fiber lengths to all remote antennas but however this is not an elegant solution. Even if the fiber lengths were equalized, differences in wireless propagation times can still produce self-interference. Optimal antenna placement and design together with signal strength management can minimize (but not entirely eliminate) the impact of self-interference.

In contrast, in the embodiment of FIG. 3 multiple independent sectors, two in this case—sectors 75 and 85, are used, and are transmitted over high gain remote antenna units 24, with the multiple sectors 75, 85 interleaved along the corridor 45 so that no handoff within the range of the base station 20, as extended by the remote antenna units 24, occurs between identical sectors. These sectors 75, 85 are typically segregated in frequency, code, time, or any combination of multiplexing methods. Intra-cell handovers are managed internally within a single base station 20 and are therefore much faster and more reliable than the inter-cell type of handover.

In the arrangement of FIG. 3, neighboring remote antenna units 24 are transmitting the signals of different sectors of the base station. FIG. 3 shows a configuration with two sectors 75 and 85 arranged in a 1-2-1-2-1-2 interleaving pattern, but there is no limit on the number of sectors used so long as all of the sectors are from a single base station. For example, a 1-2-3-1-2-3 arrangement may be desirable for some purposes. Because each sector is segregated by the base station 20 by design (using one or more multiplexing methods), interleaving sectors on the remote antenna units will eliminate self-interference. This increases the number of intra-cell handovers, but as mentioned previously, intra-cell handovers are much faster to accomplish and more reliable than the inter-cell type. Intra-cell handovers are typically sufficiently fast to easily accommodate extremely fast vehicle speeds.

The remote antenna units 24 (RAUs 24) of the embodiment of FIG. 3 are connected back to the base station or head-end via a fiber link 22. The RAUs 24 essentially replicate the signal generated by the base station 20, in the downlink direction 26, as well as replicate the signal generated by a mobile station in the uplink direction 28. The system represented in FIG. 3 is thus in part a fiber-based one-to-many (and many-to-one) repeater system.

The advantages of systems of the type in FIG. 3 are generally maximized by maximizing the number of RAUs 24 per base station 20, as this minimizes the iner-cell handovers. However, large numbers of RAUs connected to a single base station 20 and head-end unit can produce severe multipath effects that can compromise data integrity. This happens for example when the receiver receives multiple copies of the same signal at different times transmitted by different RAUs with different arrival times caused by delays arising from different fiber and wireless distances. Like an echo, the mistimed data will create interference at the receiver. Loss of data results and overall data rate is thus reduced.

MDAS systems also generally have high wireless transmission power requirements as coverage areas to be covered are typically large. For extensively deployed DAS for mobile broadband, many RAUs are needed to ensure sufficiently high signal-to-noise ratio to support high data rates such as prescribed in such 4th generation broadband wireless access protocols. Thus, the total power consumption for many RAUs can be substantial.

With increasing RAUs in a DAS system, the numerous active uplink RAU circuits are also continuously contributing to noise to the receiver at the base station 20 or head-end. This increases the noise floor for reception at the base station and thus reduces receiver sensitivity and overall performance. The total noise floor of the system increases with increasing number of active RAUs. In a large DAS system, the increase in overall noise floor will reduce the sensitivity of the receiver and reduce the effective coverage size of the individual RAUs.

Accordingly, as another embodiment or aspect of the present invention, the RAUs 24 of systems such as that shown in FIG. 3 are individually capable to detect mobile transceivers and switch themselves into active or into standby mode as needed.

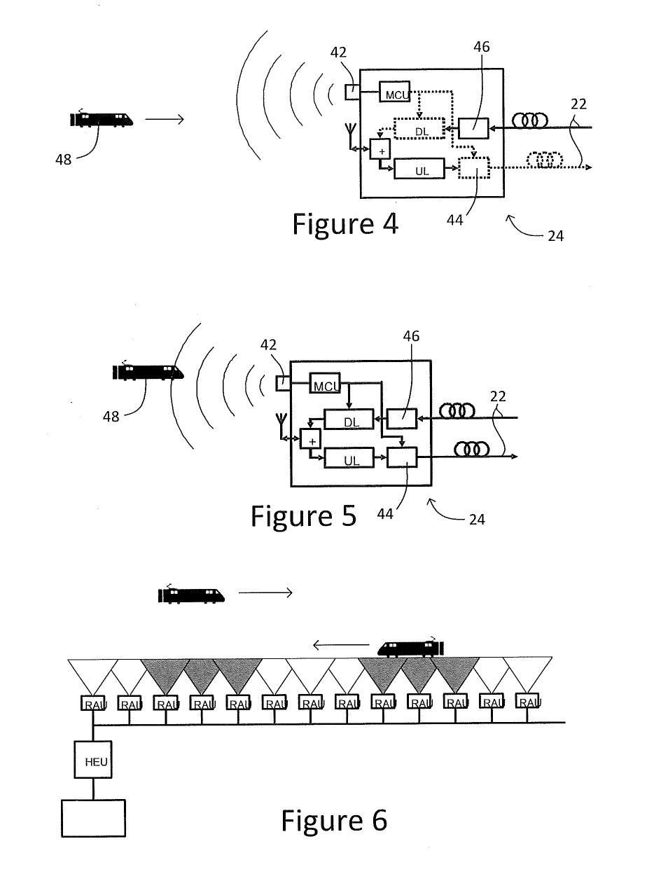

FIG. 4 shows a general block diagram of an embodiment of and RAU 24 equipped with a proximity sensor 42, a bidirectional amplifier stage UL and DL, lasers 44, photo detectors 46, and a microcontroller interface MCU. The RAU 24 is depicted in FIG. 4 in the standby mode. In this mode, the proximity sensor 42 has not yet, that is, does not at present, sense the presence of a mobile vehicle 48 with mobile transceiver(s). Therefore in this standby is mode, the proximity sensor 42 relays a signal representative of no vehicle in its area of service. The MCU reads this signal and interprets this as no vehicle in its service area and places or keeps the RAU 24 in standby mode.

When a vehicle 48 enters the service area of the RAU as represented in FIG. 5, the proximity sensor 42 relays a signal to the MCU and it compares this signal strength with the threshold level representative of a “vehicle within service area” state. When the vehicle 38 is in the coverage area, the threshold is met and the MCU pulls both the amplifiers DL and the laser UL out of standby mode and into active mode. This action therefore completes the downlink (DL) and uplink (UL) path for data packets to be transmitted to the mobile transmitter and back to the base station head end unit via the fiber link 22 connected to the newly activated RAU 24.

An alternate embodiment uses the wireless signal strength itself rather than an independent sensor to determine the presence of the vehicle in the service area. The signal strength transmitted by the mobile transmitter is received by the antenna of the RAU and a portion of the received signal is then coupled to a power detecting circuit for proximity sensing.

FIG. 6 shows a system of the general type of the embodiment of FIG. 3 using RAUs of the general type of the embodiment shown in FIGS. 4 and 5. In the normal state, each RAU is in a default standby mode (with coverage area un-shaded in the figure), but independently sensing for the presence of a mobile device approaching its vicinity. RAUs in the vicinity of the vehicle are in active mode (with coverage area shaded in the figure). No control signal from the base station head end unit is required for the switching activity, as each RAU will autonomously monitor for approaching vehicles and activate itself. When there are no in-band mobile radio devices around, the RAU remains in standby mode and some portion of the DL and UL circuits are rendered inactive. Each RAU monitors its respective service area independently using one of more proximity sensors. The proximity sensors present a signal of output strength proportional to decreasing distance. When this proximity signal exceeds a pre-determined threshold at a respective RAU, the RAU is put into active mode. This threshold level corresponds to the proximity sensor signal level when the vehicle is within the respective coverage area. Upon the vehicle exiting the coverage area, the proximity signal falls below this pre-determined threshold and the respective RAU returns to standby mode. Therefore, the proximity signal serves as a trigger signal to place the RAU into standby or active mode. When a vehicle with a mobile transmitting device travels along the route of passage, each of the RAUs will switch itself into the active mode whenever the vehicle is within the coverage area of the respective RAU. Once in active mode, the previously inactive DL and UL circuits will be pulled out of standby and resume normal operation; transmitting and receiving signals from the mobile transmitting device via radio over fiber link. Once the vehicle leaves the respective area of the RAU, the RAU senses this event via the predetermined threshold level via proximity sensor and returns to the standby mode. The threshold levels of the RAUs are desirably configured such that no more than 3 RAUs will be put into active mode at any one time, per vehicle, as shown in FIG. 6. In this particular scenario there are 2 vehicles, with three RAUs activated for each vehicle.

For the purposes of describing and defining the present invention, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is also noted that recitations herein of “at least one” component, element, etc., should not be used to create an inference that the alternative use of the articles “a” or “an” should be limited to a single component, element, etc.

It is noted that recitations herein of a component of the present disclosure being “programmed” in a particular way, “configured” or “programmed” to embody a particular property, or function in a particular manner, are structural recitations, as opposed to recitations of intended use. More specifically, the references herein to the manner in which a component is “programmed” or “configured” denotes an existing physical condition of the component and, as such, is to be taken as a definite recitation of the structural characteristics of the component.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

For the purposes of describing and defining the present invention it is noted that the term “approximately” is utilized herein to represent the inherent degree of uncertainty that may be attributed to any quantitative comparison, value, measurement, or other representation. The term “approximately” is also utilized herein to represent the degree by which a quantitative representation may vary from a stated reference without resulting in a change in the basic function of the subject matter at issue.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Rather, the claims appended hereto should be taken as the sole representation of the breadth of the present disclosure and the corresponding scope of the various inventions described herein. Further, it will be apparent that modifications and variations are possible without departing from the scope of the invention defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

1. Broadband wireless mobile communication system for high a speed mobile transportation corridor comprising:
a base stations utilizing two or more sectors;
a distributed antenna system connected to the base station and including remote antenna units distributed along the corridor and sectors of the respective base station with sectors of the base station interleaved among the remote antenna units such that no two adjacent antennas use signals from the same sector.

2. The broadband wireless mobile communication system according to claim 1 wherein the distributed antenna system is a radio over fiber distributed antenna system.

3. The broadband wireless mobile communication system according to claim 1 wherein at least one of the remote antenna units is an autonomous sensing remote antenna unit structured so as toggle between standby and active modes in response to locally sensed presence of a mobile transceiver along the corridor.

4. The broadband wireless mobile communication system according to claim 1 wherein each of the remote antenna units is an autonomous sensing remote antenna unit structured so as toggle between standby and active modes in response to the presences of a mobile transceiver along the corridor.

5. The broadband wireless communications system according to claim 3 wherein the autonomous sensing remote antenna unit includes lasers and photodetectors which are unpowered in the standby mode and powered in the active mode.

6. The broadband wireless communications system according to claim 3 wherein the autonomous sensing remote antenna unit includes amplifiers which are unpowered in the standby mode and powered in the active mode.

7. A method of operating a broadband wireless mobile communication system for high a speed mobile transportation corridor comprising:
providing a base station utilizing two or more sectors;
providing a distributed antenna system connected to the base station and including remote antenna units distributed along the corridor and sectors of the respective base station with sectors of the base station interleaved among the remote antenna units such that no two adjacent antennas use signals from the same sector; and
using intra-cell switching between sectors of the base station to transfer wireless communications from one remote antenna unit to the next.

8. The method of operating a broadband wireless mobile communication system according to claim 7 further comprising the step of sensing, at the respective mobile antenna units, the presence and/or absence of a mobile wireless transceiver along the corridor within the operating area of the respective remote antenna unit.

9. The method of operating a broadband wireless mobile communication system according to claim 8 further comprising the step of placing the respective remote antenna unit in an active mode when a mobile wireless transceiver is sensed within the operating area of the respective remote antenna unit, and/or placing the respective remote antenna unit in a standby mode when a mobile wireless transceiver is not sensed within the operating area of the respective remote antenna unit.

10. The method of operating a broadband wireless mobile communication system according to claim 9 placing in standby mode includes un-powering lasers, photodiodes and amplifiers in the remote antenna unit and placing in active mode includes powering lasers, photodiodes and amplifiers in the remote antenna unit.
